(19) United States
(12) Patent Application Publication
(10) Pub. No.: US 2016/0349286 A1
(43) Pub. Date: Dec. 1, 2016

(54) MICROMECHANICAL ACCELERATION SENSOR

(71) Applicant: Robert Bosch GmbH, Stuttgart (DE)

(72) Inventors: Guenther-Nino-Carlo Ullrich, Reutlingen (DE); Benny Pekka Herzogenrath, Stuttgart (DE)

(21) Appl. No.: 15/159,950

(22) Filed: May 20, 2016

(30) Foreign Application Priority Data
May 29, 2015 (DE) 102015209941.5

(51) Int. Cl. G01P 15/125

(52) U.S. Cl. CPC G01P 15/125

(57) ABSTRACT

A micromechanical acceleration sensor, having at least two identically fashioned micromechanical sensor cores, wherein the two sensor cores on the acceleration sensor are configured so as to be rotated by 180° relative to one another, or one of the two sensor cores is configured in mirrored fashion in relation to an axis running centrically through the other of the two sensor cores and oriented orthogonally to a transverse force capable of acting on the acceleration sensor.

### CROSS REFERENCE

The present application claims the benefit under 35 U.S.C. §119 of German Patent Application No. DE 102015209941.5 filed on May 29, 2015, which is expressly incorporated herein by reference in its entirety.

### FIELD

The present invention relates to a micromechanical acceleration sensor. The present invention further relates to a method for producing a micromechanical acceleration sensor.

### BACKGROUND INFORMATION

Conventional sensors for measuring physical acceleration standardly have a micromechanical structure made of silicon (sensor core) and an evaluation electronics unit. Sensor cores that make it possible to measure an acceleration in a direction orthogonal to a main plane of the sensor core are referred to as Z sensors. Such sensors are used in automotive engineering, for example in ESP systems or in mobile radiotelephony.

Conventional micromechanical lateral sensors, or in-plane sensors, are used to acquire acceleration in a main plane of the in-plane sensors.

European Patent No. EP 0 773 443 B1 describes a micromechanical acceleration sensor.

In the context of a functionalization of functional layers, described, for example, in German Patent Application Nos. DE 10 2007 060 878 A1 and DE 10 2009 000 167 A1, for the micromechanical acceleration sensor a rocker is fashioned that is structured not only in a single compact layer, but rather in two different silicon layers. In this way, movable tub-shaped structures can be formed.

### SUMMARY

An object of the present invention is to provide a micromechanical acceleration sensor having improved operating characteristics.

According to a first aspect of the present invention, this object may be achieved by a micromechanical acceleration sensor having at least two identically fashioned micromechanical sensor cores, characterized in that the two sensor cores on the acceleration sensor are situated so as to be rotated by 180° relative to one another, or that one of the two sensor cores is situated in mirrored fashion in relation to an axis that runs centrically through the other of the two sensor cores and is aligned orthogonally to a transverse force that can act on the acceleration sensor.

According to a second aspect, the object may be achieved by a method for producing a micromechanical acceleration sensor having the steps:
fashioning at least two identically fashioned micromechanical sensor cores;
one of the two sensor cores on the acceleration sensor being situated so as to be offset by 180° relative to the other sensor core; or
one of the two sensor cores being situated in mirrored fashion in relation to an axis that runs centrically through the other of the two sensor cores and is aligned orthogonally to a transverse force that can act on the acceleration sensor.

In this way, it can advantageously be achieved that the acceleration sensor is, to the greatest possible extent, not sensitive to cross-acceleration. This is achieved in that the two identical sensor cores deflect in opposite directions to one another, whereby an evaluation circuit ascertains two signals running opposite one another, so that no cross-acceleration is detected.

Advantageous developments of the acceleration sensor are characterized in that the at least two micromechanical sensor elements are fashioned as Z sensor cores and/or as in-plane sensor cores. In this way, the design according to the present invention can be realized with different micromechanical sensor cores.

A further advantageous development of the acceleration sensor is distinguished in that the Z sensor cores each have a rocker mounted about a spring element, the spring element being fashioned as a so-called T spring or a so-called I spring; in principle, any type of spring can produce a systematic or random error that causes a cross-sensitivity of the acceleration sensor. In this way, different shape designs can be realized for the Z sensor core.

Below, the present invention is described in detail, with further features and advantages, on the basis of a plurality of Figures. Here, all described features, in themselves or in arbitrary combination, form the subject matter of the present invention, independent of their representation in the description or in the Figures. Identical or functionally identical elements have identical reference characters. The Figures are not necessarily to scale.

### BRIEF DESCRIPTION OF THE DRAWINGS

FIG. 1 shows a conventional micromechanical Z sensor core.

FIG. 2 shows a cross-sectional view of a conventional micromechanical Z sensor core.

FIG. 3 shows a cross-sectional view of a further conventional micromechanical Z sensor core.

FIGS. 4-8 show cross-sectional views of conventional micromechanical Z sensor cores.

FIG. 9 show a cross-sectional view of a conventional micromechanical acceleration sensor.

FIG. 10 shows a top view of a conventional micromechanical acceleration sensor.

FIG. 11 shows a cross-sectional view of a specific embodiment of a micromechanical acceleration sensor according to the present invention.

FIG. 12 shows a top view of a specific embodiment of a micromechanical acceleration sensor according to the present invention.

FIG. 13 shows a top view of an in-plane sensor core.

FIG. 14 shows a schematic flow diagram of a specific embodiment of the method according to the present invention.

### DETAILED DESCRIPTION OF EXAMPLE EMBODIMENTS

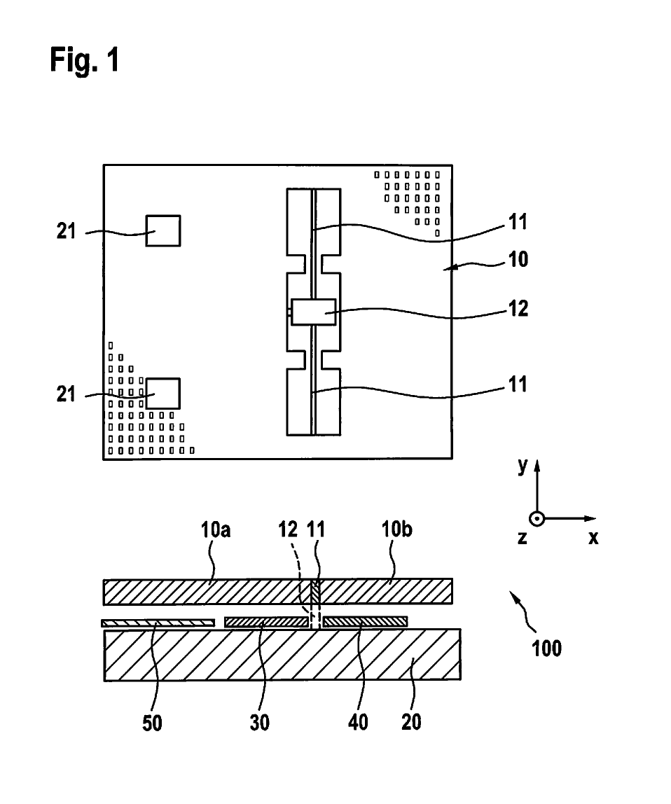

FIG. 1 shows, in greatly simplified fashion, a conventional micromechanical Z sensor core 100 in a top view (upper representation) and in a cross-sectional view (lower representation). The micromechanical Z sensor core 100 has a perforated movable flat rocker 10. The perforation of rocker 10 was produced using etching processes, and completely covers the rocker area. Using two spring elements 11, preferably fashioned as torsion springs having defined rigidities, rocker 10 is mounted or suspended on a substrate 20 (preferably an Si substrate) so as to be capable of rotation or torsional twisting. Arms 10a, 10b of rocker 10 are here fashioned asymmetrically relative to a torsion axis formed by spring elements 11, with regard to their physical masses. Given arms 10a, 10b having generally the same length (geometrical symmetry), the asymmetry can be realized through an asymmetrical mass distribution of arms 10a, 10b (e.g., through different perforations of arms 10a, 10b, or through different thicknesses of the two arms 10a, 10b). However, in addition or alternatively the asymmetry can also be realized through an asymmetry of a geometry of the two arms 10a, 10b (e.g., different arm lengths).

In FIG. 1, the named asymmetry is indicated by different lengths of the two arms 10a, 10b of rocker 10 (long arm 10a, short arm 10b). As a result of an acceleration (vertical acceleration) acting orthogonally to a main plane of rocker 10 (in the Z direction), the structure of rocker 10 can twist about the torsion axis due to the asymmetry of the two arms 10a, 10b. By an electronic circuit (not shown), rocker 10 is held at an electrical potential PM, and electrodes 30, 40, used for measurement purposes and situated underneath rocker 10, are held at electrical potentials P1 and P2. In addition, underneath long arm 10a an electrode 50 is situated on substrate 20 and is also held at electrical potential PM. A plurality of mechanical stop elements 21 in substrate 20 are intended to ensure that in the case of overload the rocker structure stops at defined points on substrate 20, and are intended to prevent rocker 10 from reaching or exceeding a critical deflection in the case of lateral overload accelerations. In this way, the sensor is to be effectively protected from mechanical overloading in the main plane and the resulting damage. In the cross-sectional view of FIG. 1, a connecting element 12 of rocker 10 can be seen for the functional connection of rocker 10 to substrate 20 below it.

A change in the inclination of rocker 10 is detected by an electronic evaluation device (not shown), through acquisition and evaluation of charge changes at electrodes 30, 40. In this way, the vertical accelerations acting on micromechanical Z sensor core 100 can be ascertained. A downward deflection of arm 10a is here limited by a surface of substrate 20, or by electrode 50 situated on substrate 20, whereby arm 10a stops on electrode 50 already in the case of a relatively small vertical acceleration.

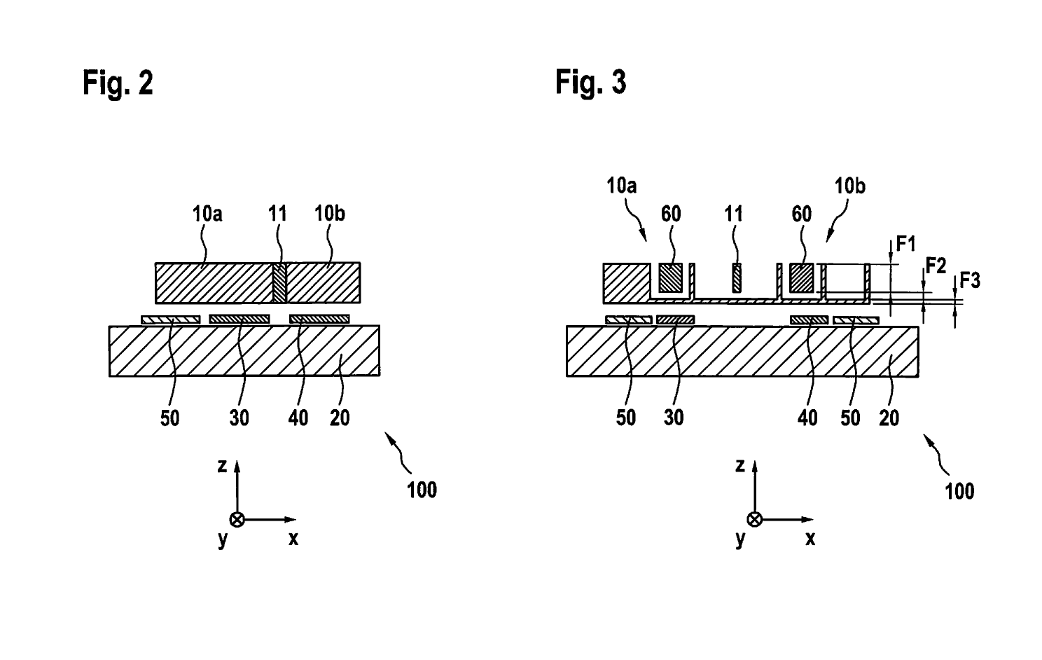

FIG. 2 shows the structure of FIG. 1, again simplified relative to a variant shown in FIG. 3 of Z sensor core 100.

In the sectional view of FIG. 3, it will be seen that the overall structure of rocker 10 is made up of three functional layers, namely a first functional layer F1 at the top, a second functional layer F2 situated between first functional layer F1 and a third functional layer F3, and third functional layer F3 at the bottom. Second functional layer F2 can also be omitted if needed.

As a result of an acceleration acting orthogonal to a main plane of rocker 10 (vertical acceleration in the Z direction), the structure of rocker 10 can twist about torsion spring 11 due to the asymmetry of the two rocker arms 10a, 10b. Rocker 10 is held at a defined electrical potential by an electronic circuit (not shown), and stationary second electrodes 30, 40, 50, used for measurement purposes and situated underneath rocker 10, are held at other defined electrical potentials. Visible are the tub-shaped structures of rocker arms 10a, 10b, stationary electrodes 16 being situated above the tub-shaped structures.

A change in inclination of rocker 10 is detected using an electronic evaluation device, through acquisition and evaluation of changes in charge at electrodes 30, 40, 50, 60. In this way, a vertical acceleration acting in the Z direction on micromechanical Z sensor core 100 can be ascertained.

In rocker 10 shown in FIG. 3, a problem can be that the mass midpoints of spring element 11 and of rocker 10 can be offset relative to one another. As a result, it can happen that, given a lateral force F on rocker 10, an undesirable torsional movement of rocker 10 is produced. In this way, when a transverse force is applied a parasitic acceleration can be sensed by Z sensor core 100.

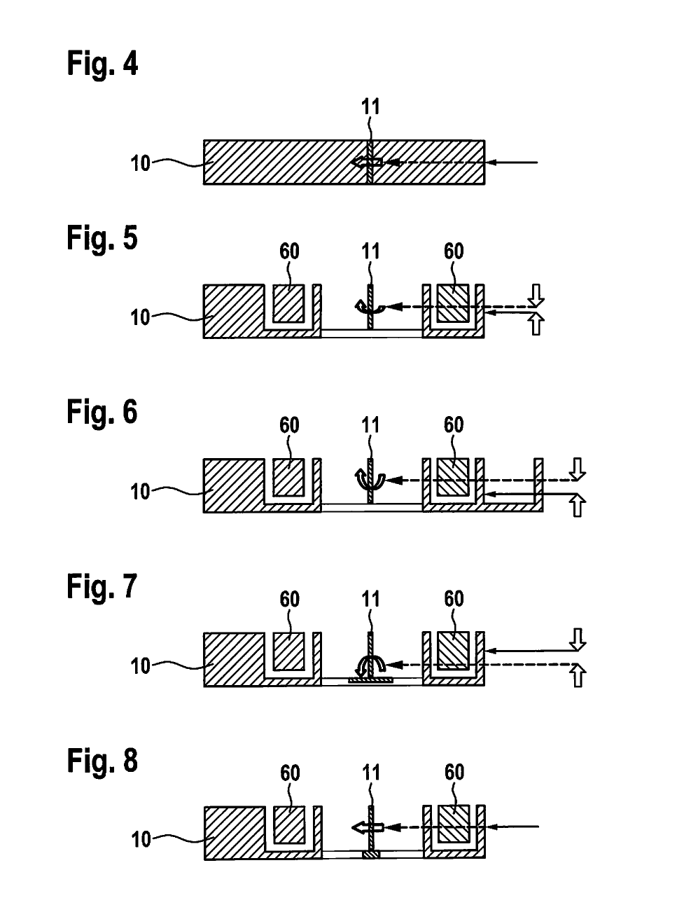

FIG. 4 shows a cross-sectional view through a rocker 10 that remains horizontal when there is a transverse force, because the mass center of gravity and the point of rotation of spring element 11 are generally at the same level. Rocker 10 thus remains flat, and no signal is generated.

FIG. 5 shows the structure of a rocker 10 according to FIG. 3, rocker 10 being formed from functional layers F1 through F3. Spring element 11 is realized in first functional layer F1. The mass center of gravity of rocker 10 is no longer situated at half the height of the layer construction, as in the structure of FIG. 4. The point of rotation of spring element 11 is situated in the center of first functional layer F1. However, because the point of rotation of spring element 11 and the mass center of gravity of rocker 10 can be situated at different heights as a result of the process, when there is a lateral acceleration rocker 10 is deflected and thus produces a faulty signal, referred to as “cross-sensitivity” of rocker 10.

A further variant of a conventional rocker 10 is shown in FIG. 6. In this case, rocker 10 is fashioned in such a way that a base surface of rocker 10 is fashioned symmetrically relative to spring element 11. The mass asymmetry required for a deflection of rocker 10 when there is a vertical acceleration is achieved through different thicknesses of rocker 10. As a result, in rocker 10 of FIG. 6 the cross-sensitivity is higher than in rocker 10 of FIG. 5.

FIG. 7 shows a variant of rocker 10 having a so-called T-spring. Rocker 10 can be fashioned corresponding to FIG. 5 or FIG. 6. Through a cross-beam in spring element 11, the point of rotation of rocker 10 is displaced far enough that when there is a cross-acceleration rocker 10 deflects in the other direction, indicated by the directional arrow of FIG. 7.

An improvement in the cross-sensitivity can be achieved by a structure of a conventional rocker 10 shown in FIG. 8. Here, a combination of a thin spring in third functional layer F3 and a broad spring in first functional layer F1 can realize a so-called I-spring having a particularly advantageous cross-sensitivity, because in this way the center point of rotation and the center point of mass of rocker 10 are situated at approximately the same height. However, even this I-spring cannot completely prevent the influence of a cross-acceleration on the detection of a vertical acceleration, and in addition has disadvantages with regard to rigidity compared to a highly cross-sensitive T-spring.

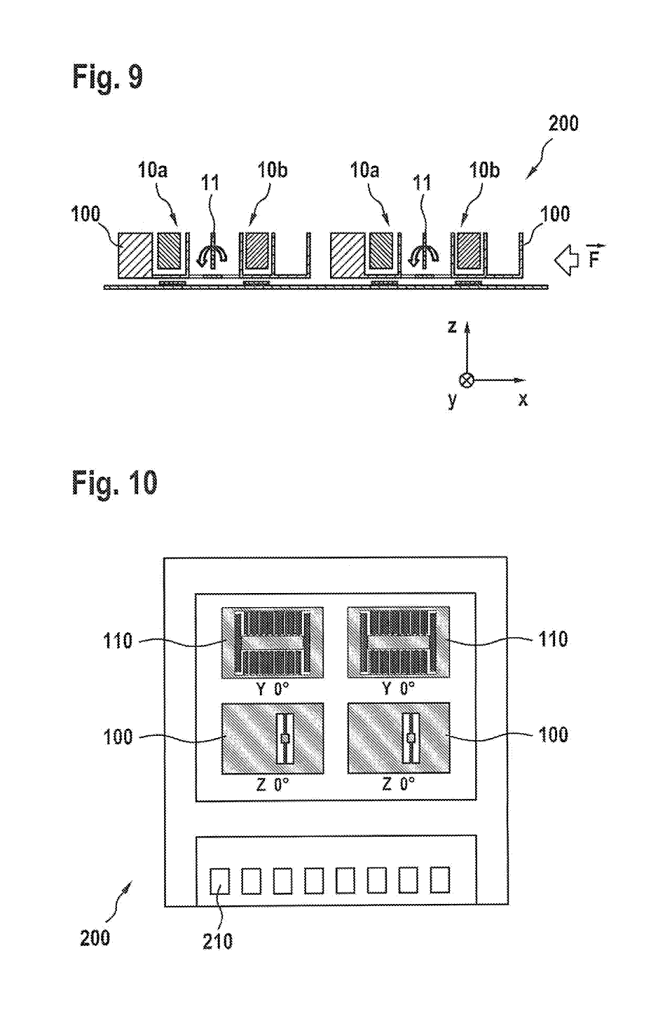

FIG. 9 shows a cross-sectional view of a conventional fully differential cross-sensitive micromechanical acceleration sensor 200, having two identically fashioned Z sensor cores 100, a force F acting laterally on acceleration sensor 200 being indicated. If this force accelerates acceleration sensor 200 to the left, then, due to cross-sensitive rocker 10, the resulting torque will press mass-rich rocker arms 10a downward, so that as a result an acceleration in the Z direction is sensed that is actually not present.

FIG. 10 shows a top view of a conventional micromechanical acceleration sensor 200 having two pairs of identically fashioned Z sensor cores 100 and in-plane sensor cores 110, the two pairs of sensor cores 100, 110 on acceleration sensor 200 being configured in the same direction. Bonding pads 210 are provided for an electrical connection of sensor cores 100, 110 to the electronic evaluation circuit of acceleration sensor 200.

In order to reduce the cross-sensitivity of acceleration sensor 200, it is proposed that the two pairs of sensor cores 100, 110 be specifically situated on acceleration sensor 200, whereby compensate the cross-sensitivity of micromechanical sensor cores 100, 110 can be compensated. This is achieved in that two identically fashioned sensor cores 100, 110 are situated on acceleration sensor 200 so as to be rotated by 180° relative to one another. Alternatively, this can also be achieved in that one of the two sensor cores 100, 110 is configured in mirrored fashion in relation to an axis that runs centrically through the other of the two type-identical sensor cores 100, 110, orthogonally to a transverse force F capable of acting on acceleration sensor 200.

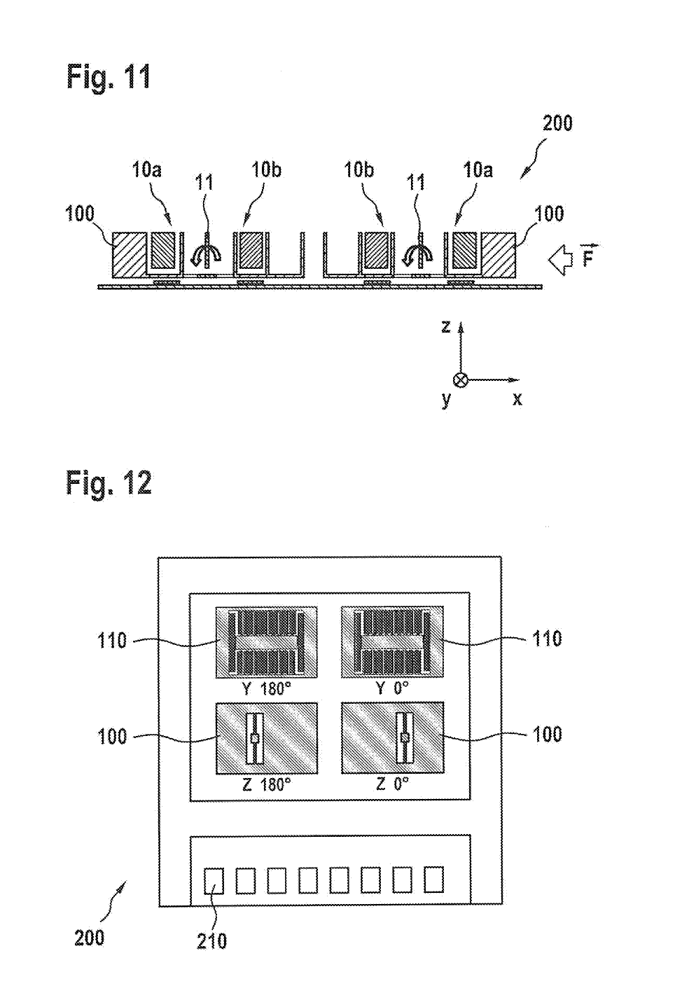

FIG. 11 shows a cross-sectional view through two Z sensor cores 100 situated on acceleration sensor 200 so as to be mirrored relative to one another or rotated by 180° relative to one another. It will be seen that mass-rich arms 10a of rocker 10 are oriented away from one another. In this way, when there is a transverse force on the two Z sensor cores 100, the two Z sensor cores 100 are deflected in complementary fashion, whereby the evaluation circuit compensates the two acceleration signals of the two Z sensor cores 100. In this way, a transverse force insensitivity of acceleration sensor 200 can be realized easily. Spring element 11 can be fashioned here as a T spring or as an I spring.

FIG. 12 shows a top view of a specific embodiment of an acceleration sensor 200 according to the present invention. It will be seen that in the lower region of acceleration sensor 200, a Z sensor core 100 is configured so as to be rotated by 180° relative to the other Z sensor core 100. In the upper region of acceleration sensor 200, an in-plane sensor core 110 is configured so as to be rotated by 180° relative to the other in-plane sensor core 110. As a result, in this way a micromechanical sensor module is advantageously provided that is maximally insensitive to cross-acceleration.

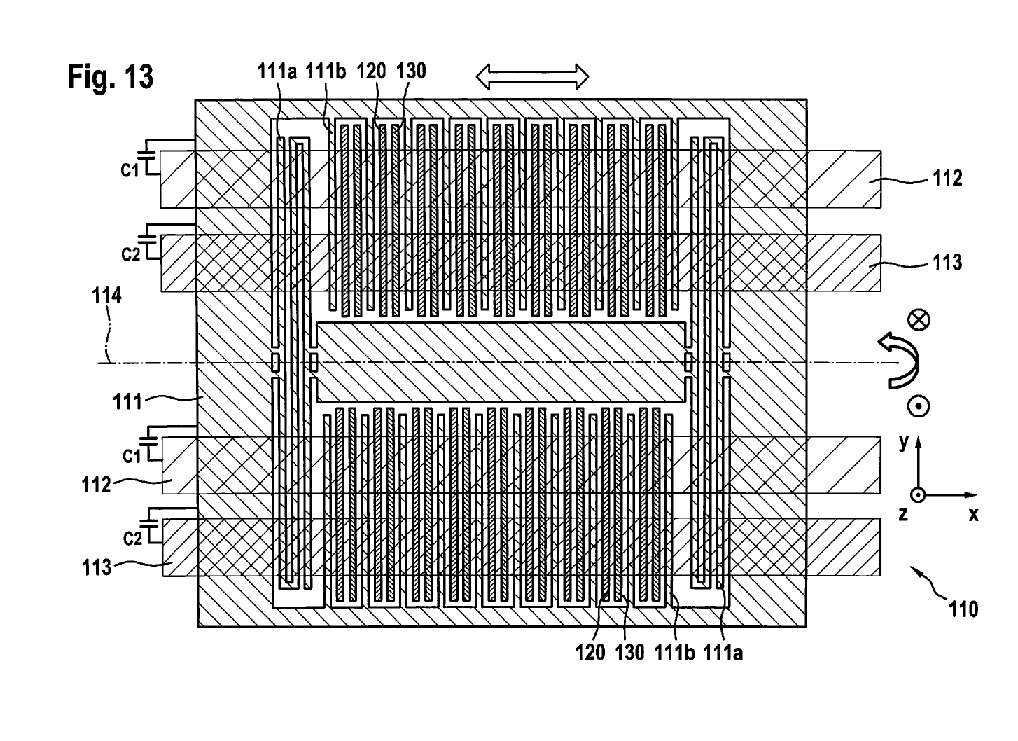

FIG. 13 shows a top view of an in-plane sensor core 110 for which it is also possible to compensate a parasitic acceleration in the Z direction due to transverse force. In-plane sensor core 100 has a seismic mass 111, suspended on a spring 111a, having electrode fingers 111b and fixed electrodes 120, 130 that are anchored in stationary fashion on the substrate (not shown). Seismic mass 111 is at electrical potential PM, while fixed electrodes 120, 130 are at potential P1 and P2.

Between potentials PM and P1, or PM and P2, a capacitance is formed that changes when an external mechanical acceleration is applied to in-plane sensor core 110, because seismic mass 111 is deflected and in this way the distance from movable electrode fingers 111b to fixed electrodes 120, 130 is made larger or is made smaller. These changes in capacitance can be measured using an electronic evaluation circuit (not shown), and in this way the applied acceleration can be ascertained. A double arrow indicates a direction of movement of seismic mass 111.

Visible are two wiring levels 112 and 113, at electrical potentials P1 or P2. A capacitance C1 between wiring level 112 and seismic mass 111, or a capacitance C2 between wiring level 113 and seismic mass 111, changes when there is a rotational deflection of seismic mass 111 about an axis of rotation in the X direction; here in fact no signals should be generated, because distances between electrode fingers 111b in the X direction do not change. Vertical displacements of electrode fingers 111b of seismic mass 111 take place symmetrically at both sides, relative to electrodes 120, 130, and should therefore be averaged out in the differential evaluation.

However, the core wiring in the so-called trenched polysilicon layer can be problematic. This layer forms, in addition to the mentioned useful capacitances C1 (between wiring level 112 and seismic mass 111) and C2 (between wiring level 113 and seismic mass 111), a parasitic capacitance with the epitaxial polysilicon level from which seismic mass 111 is formed. Because potentials P1 and P2 are carried in wiring level 112, 113, and in the polysilicon level situated thereabove seismic mass 111 is at ground potential PM, the evaluation circuit cannot distinguish the named potentials from the capacitance between electrode fingers 120, 130, and senses an applied lateral acceleration when the parasitic capacitances between wiring levels 112, 113 and seismic mass 111 change due to pivoting of seismic mass 111 about the X axis.

This is because if, as indicated, in-plane sensor core 110 rotates about the X axis, then the P1-PM capacitance there will become greater than the P2-PM capacitance, because it has a larger surface and is situated further away, because in this case seismic mass 111 comes closer to wiring levels 112, 113.

In the lower region of in-plane sensor core 110, which moves in the Z direction, the two named capacitances become smaller because seismic mass 111 is further away from wiring levels 112, 113. Because, however, here P1 is closer to the center, the decrease in the capacitance is less than the increase of the capacitance in the upper region. P2 behaves in the correspondingly opposite manner, so that P2-PM in sum becomes smaller, so that as a result a cross-sensitivity arises of the known in-plane sensor core 110.

The named cross-sensitivity can easily be removed, as described above analogously with reference to Z sensor core 100, through a configuration of in-plane sensor core rotated by 180° relative to a second identically fashioned in-plane sensor core 110. FIG. 12 shows, in its upper part, two in-plane sensor cores 110 configured in this manner.

In variants not shown of acceleration sensor 200, it is also advantageously possible for an acceleration sensor 200 to have either only two Z sensor cores 100 or only two in-plane sensor cores 110.

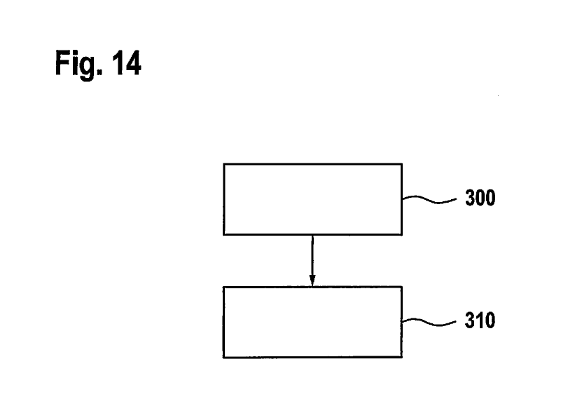

FIG. 14 shows a schematic flow diagram of a specific embodiment of the method according to the present invention.

In a first step 300, at least two identically fashioned micromechanical sensor cores 100, 110 are fashioned.

In a second step 310, an evaluation circuit is fashioned for evaluating electrical signals of the at least two identically fashioned sensor cores 100, 110, one of the two identically fashioned sensor cores 100, 110 on the acceleration sensor being offset by 180° relative to the other identically fashioned sensor core 100, 110, or one of the two sensor cores 100, 110 being configured in mirror fashion in relation to an axis running centrically through the other of the two sensor cores 100, 110 and oriented orthogonally to a transverse force F capable of acting on acceleration sensor 200.

In sum, the present invention provides a micromechanical acceleration sensor that can advantageously compensate a parasitic cross-sensitivity to the greatest possible extent. As a result, a cross-sensitivity due to a movement in the opposite direction of a second identically fashioned micromechanical sensor core is eliminated in that the evaluation circuit, using a mean value formation, averages out the parasitic sensor signals of the two sensor cores, and in this way eliminates them.

Advantageously, it is also possible to apply the principle of the present invention to other sensor technologies, for example to piezoresistive micromechanical acceleration sensors.

Although the present invention has been described on the basis of concrete specific embodiments, it is in no way limited thereto. The person skilled in the art will recognize that many modifications are possible that are not described above, or are only partially described above, without departing from the core idea of the present invention.

What is claimed is:

1. A micromechanical acceleration sensor, comprising:
at least two identically fashioned micromechanical sensor cores, the two sensor cores being configured so as to be rotated by 180° relative to one another.

2. The micromechanical acceleration sensor as recited in claim 1, wherein the at least two micromechanical sensor cores are fashioned as Z sensor cores.

3. The micromechanical acceleration sensor as recited in claim 1, wherein the at least two micromechanical sensor cores are fashioned as in-plane sensor cores.

4. A micromechanical acceleration sensor, comprising:
at least two identically fashioned micromechanical sensor cores, one of the two sensor cores being configured in mirrored fashion in relation to an axis running centrically through the other of the two sensor cores and oriented orthogonally to a transverse force capable of acting on the acceleration sensor.

5. The micromechanical acceleration sensor as recited in claim 4, wherein the at least two micromechanical sensor cores are fashioned as Z sensor cores.

6. The micromechanical acceleration sensor as recited in claim 4, wherein the at least two micromechanical sensor cores are fashioned as in-plane sensor cores.

7. A method for producing a micromechanical acceleration sensor, comprising:
fashioning at least two identically fashioned micromechanical sensor cores, one of the two sensor cores being configured offset by 180° relative to the other sensor core.

8. A method of producing a micromechanical acceleration sensor, comprising:
fashioning at least two identically fashioned micromechanical sensor cores, of the two sensor cores being configured in mirrored fashion in relation to an axis running centrically through the other of the two sensor cores and oriented orthogonally to a transverse force capable of acting on the acceleration sensor.
